(19) United States
(12) Patent Application Publication
(10) Pub. No.: US 2026/0334444 A1
(43) Pub. Date: Oct. 29, 2026

(54) Tension-Release Slip Bobber and Fishing Method

(71) Applicant: Michael Hanousek, Chanhassen, MN (US)

(72) Inventor: Michael Hanousek, Chanhassen, MN (US)

(21) Appl. No.: 19/662,375

(22) Filed: Apr. 29, 2026

Related U.S. Application Data
(60) Provisional application No. 63/796,576, filed on Apr. 29, 2025.

(51) Int. Cl. A01K 93/00

(52) U.S. Cl. CPC A01K 93/00

(57) ABSTRACT

A slip bobber that operates without a separate fixed stop on the fishing line. The bobber includes a buoyant body, an eyelet defining a through-passage that slidably receives the line, and a line-retention feature spaced from the eyelet and having at least one oblique contact surface. A retention mechanism applies a calibrated transverse force to hold the line in the retention feature at a selected depth. Axial tension on the line acts on the oblique surface to generate a lateral force component; when that component exceeds the retention force, the line is urged out of the retention feature while remaining captured in the eyelet, transitioning the bobber from a fixed-depth state to a free-sliding state with no knot, bead, or other obstruction left on the line.

### CROSS-REFERENCE TO RELATED APPLICATION

This application claims the benefit of U.S. Provisional Patent Application No. 63/796,576, filed Apr. 29, 2025, entitled “Tension-Release Slip Bobber and Fishing Method,” the entire contents of which are hereby incorporated by reference.

### FIELD OF THE INVENTION

The present invention relates generally to fishing tackle and angling accessories, and more particularly to slip bobbers and depth control devices for fishing lines used in ice fishing and open water fishing applications.

### BACKGROUND OF THE INVENTION

Slip bobbers are commonly used by anglers to suspend bait, lures, or hooks at a selected depth while permitting a fishing line to slide freely through the bobber during casting and retrieval. Conventional slip-bobber systems rely on a separate bobber stop—typically a knot, bead, or clip—affixed to the fishing line to define the maximum travel distance of the bobber.

Conventional bobber stops introduce several disadvantages. Because bobber stops remain fixed to the fishing line, they must pass through rod guides and onto reel spools during retrieval, which can create abrupt changes in line tension and inconsistent pressure while fighting a fish. These abrupt changes in tension can contribute to line breakage or unintentional unhooking of fish. During ice fishing, bobber stops can catch on the edges of an ice hole, which can result in lost fish or broken line. Bobber stops can also create wear points on the fishing line, interfere with or damage rod guides during repeated retrieval, and complicate installation in cold-weather conditions.

Some conventional slip bobbers require threading the fishing line through a closed eyelet during installation. This requires the angler either to thread the line before attaching terminal tackle or to cut the line and re-tie terminal tackle whenever the bobber is added, removed, or replaced. This process is time-consuming, can waste fishing line, and can be difficult in cold weather conditions.

Accordingly, there is a need for a slip bobber that can temporarily secure itself to a fishing line at a selected depth and release under defined conditions without requiring a separate bobber stop affixed to the fishing line. There is a further need for a slip bobber configuration that permits installation and removal without requiring access to a terminal end of the fishing line.

### SUMMARY OF THE INVENTION

The present invention provides a tension-release slip bobber that temporarily retains a fishing line at a selected depth without requiring any fixed bobber stop, knot, bead, or other obstruction on the fishing line.

In one aspect, the invention comprises a buoyant bobber body, a line-retention feature configured to laterally receive and engage a fishing line and including at least one oblique contact surface, a retention mechanism configured to apply a transverse retention force to secure the fishing line within the line-retention feature, and an eyelet physically separated from the line-retention feature and configured to permit sliding of the fishing line after release from the line-retention feature.

The bobber is configured such that axial tension applied to the fishing line, acting against the at least one oblique contact surface, generates a lateral force component. When the lateral force component exceeds the transverse retention force, the fishing line is urged laterally out of the line-retention feature, transitioning the bobber from a retained depth-control state to a free-sliding state. This transition occurs without any fixed stop, knot, bead, or obstruction remaining on the fishing line between the bobber and terminal tackle.

In certain embodiments, the eyelet includes a lateral access opening narrower than the nominal diameter of a fishing line intended for use with the bobber, at least a portion of the eyelet adjacent the lateral access opening comprising a resilient material configured to elastically deform to permit the fishing line to pass through the lateral access opening into the through-passage when a manual seating force is applied. This permits installation and removal of the bobber from the fishing line without accessing a terminal end of the line.

The retention mechanism may be detachable, interchangeable, adjustable, or integrally formed with the bobber body. The retention mechanism may apply retention force through mechanical compression, spring bias, elastic deformation, magnetic attraction, friction, geometric interference, or combinations thereof.

### BRIEF DESCRIPTION OF THE DRAWINGS

FIG. 1 is a perspective view of the tension-release slip bobber in a fixed-depth state, showing the bobber body (10) with a biasing arrangement (12), guide surface (14), line-retention feature (16), eyelet (20), and lateral access opening (22), engaged with a fishing line (26) and hook (24).

FIG. 2 is a perspective view of the tension-release slip bobber in a free-sliding state, showing the bobber body (10), biasing arrangement (12), guide surface (14), line-retention feature (16), eyelet (20), and lateral access opening (22), with the fishing line (26) and hook (24).

FIG. 3 is an exploded perspective view of the tension-release slip bobber, showing the bobber body (10) separated from the biasing arrangement (12), and illustrating the guide surface (14), line-retention feature (16), eyelet (20), and lateral access opening (22).

FIG. 4 is a top plan view of the tension-release slip bobber, showing the bobber body (10), biasing arrangement (12), guide surface (14), line-retention feature (16), eyelet (20), and lateral access opening (22).

FIG. 5 is a bottom plan view of the tension-release slip bobber, showing the bobber body (10), biasing arrangement (12), guide surface (14), eyelet (20), and lateral access opening (22).

FIG. 6 is a side elevation view of the tension-release slip bobber, showing the bobber body (10) and biasing arrangement (12).

### DETAILED DESCRIPTION OF THE INVENTION

### General Structure

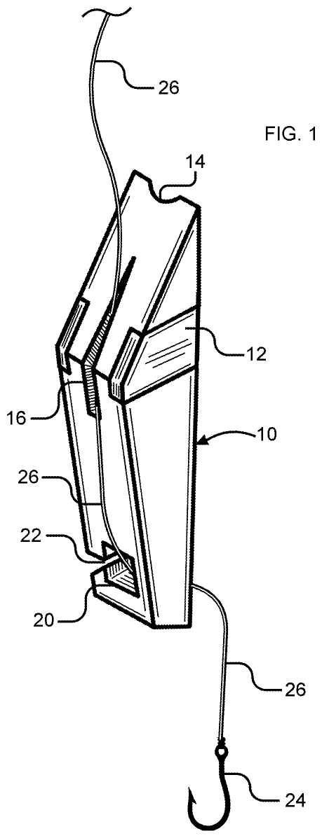

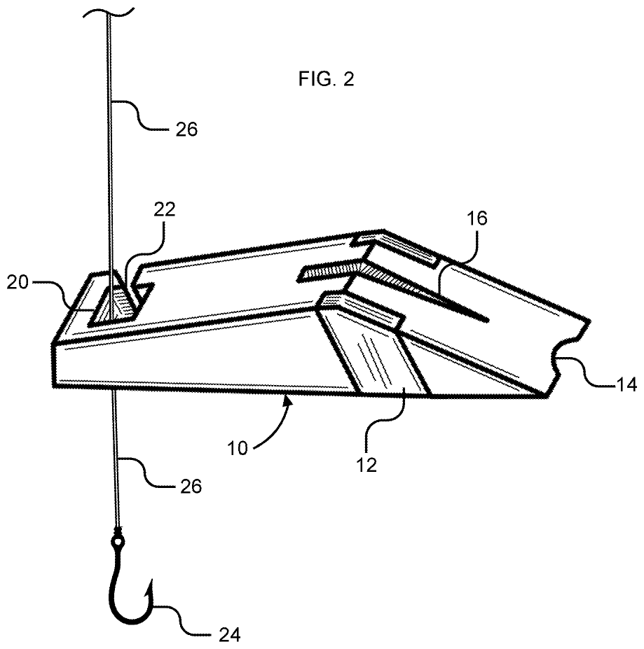

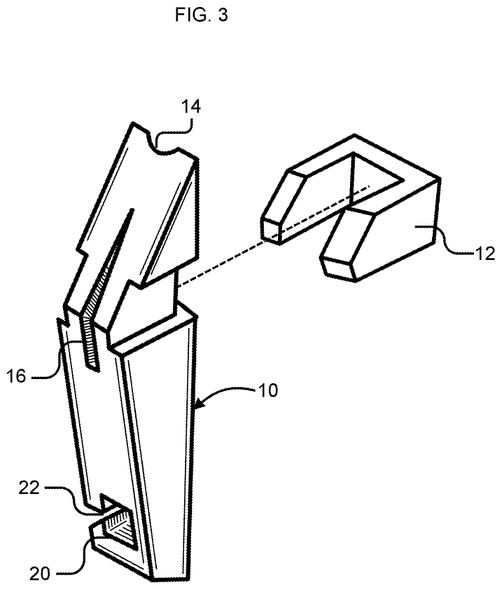

Referring to the drawings, the tension-release slip bobber comprises a bobber body (10) and a retention mechanism, shown in the illustrated embodiment as a biasing arrangement (12), configured to selectively retain and release a fishing line (26). FIGS. 1 and 2 show the assembled bobber in use, with the fishing line (26) extending through the bobber and terminating at a hook (24). FIG. 3 shows the bobber body (10) and biasing arrangement (12) in an exploded configuration to illustrate their separable relationship.

### The Bobber Body

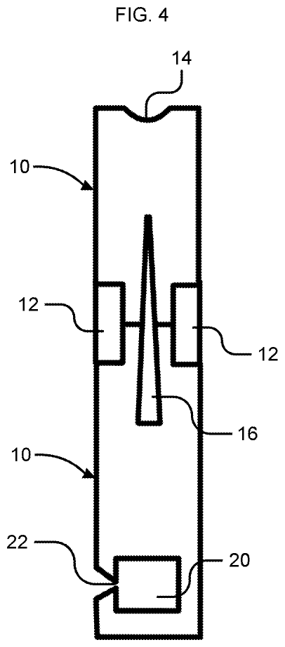

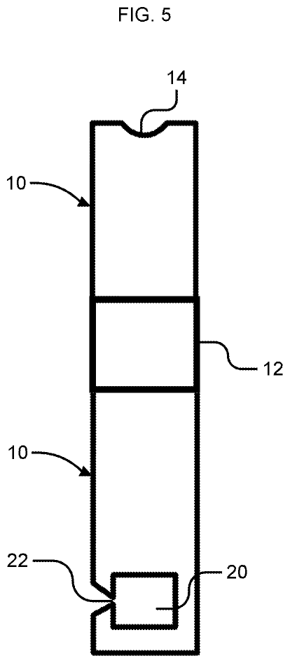

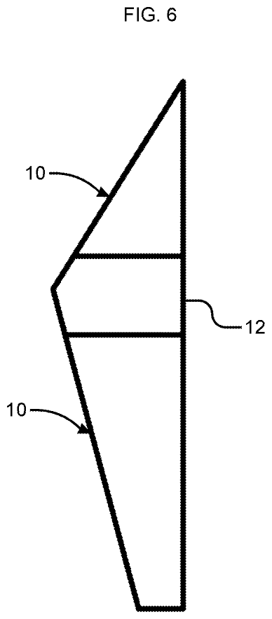

The bobber body (10), shown in FIGS. 1-6, is buoyant and may include a hollow or solid interior configured to provide flotation. The bobber body may be formed from plastic, elastomeric material, foam, wood, composite, metal, or combinations thereof. Suitable materials include expanded polystyrene foam, closed-cell polyethylene foam, ethylene-vinyl acetate (EVA) foam, balsa wood, cedar, plastic resins such as acrylonitrile butadiene styrene (ABS), thermoplastic polyurethane (TPU), polycarbonate, polypropylene, or nylon, silicone, and thermoplastic elastomers. In some embodiments, all or a portion of the bobber body comprises a buoyant foam material that is user-trimmable. A user may remove material from the foam to reduce the overall buoyancy of the bobber, allowing the user to tune buoyancy for specific bait weights, current conditions, or visibility preferences. The trimmable foam may comprise the entire bobber body, an external layer, an insert received within a cavity of the bobber body, or a removable foam component coupled to the bobber body. Suitable trimmable foam materials include expanded polystyrene foam, closed-cell polyethylene foam, ethylene-vinyl acetate (EVA) foam, polyurethane foam, cork, balsa, and similar buoyant materials capable of being cut, shaved, sanded, or otherwise reduced in volume by a user using common tools such as a knife, scissors, sandpaper, or file.

The bobber body (10) has a longitudinal axis extending from a top end to a bottom end. The bobber body may take various shapes including spherical, diamond, triangular, teardrop-shaped, oval, elongated, cylindrical, bullet-shaped, or combinations thereof. The illustrated embodiment shows an elongated, generally tapered profile.

In some embodiments, the bobber body has a maximum transverse dimension greater than 16 millimeters such that contact between the bobber body and an internal periphery of a standard fishing rod guide during retrieval applies a lateral dislodging force to the fishing line, aiding release of the fishing line from the line-retention feature.

### Line-Retention Feature

A line-retention feature (16), visible in FIGS. 1-4, is formed in or on the bobber body (10) and is configured to receive a fishing line (26) in a laterally displaced condition relative to the longitudinal axis of the fishing line (26). In the illustrated embodiment, the line-retention feature (16) comprises an open-sided channel formed in an exterior surface of the bobber body (10). The channel may have parallel walls, tapered walls, curved walls, or combinations thereof.

The line-retention feature (16) may alternatively comprise a channel with partial covering, a plurality of contact points arranged circumferentially around the fishing line (26), a clamp having opposing surfaces, a recess containing flexible elements, or a combination of such configurations.

In embodiments comprising contact points, the contact points may comprise projections, tabs, pins, posts, bumps, ridges, or raised surfaces that extend inwardly toward the fishing line when the retention mechanism applies the retention force. For example, three or four contact points may be positioned at approximately equal angular intervals around the line-retention feature (16) to distribute retention force circumferentially and reduce localized pressure.

The line-retention feature (16) includes at least one contact surface oriented at an oblique angle relative to the longitudinal axis of the fishing line (26). When axial tension is applied to the fishing line (26), the oblique contact surface causes a lateral force component to develop. When the lateral force component exceeds the retention force applied by the retention mechanism, the fishing line (26) is urged laterally out of the line-retention feature (16). For purposes of this disclosure, this lateral force component generated by the action of axial tension upon the at least one oblique contact surface is referred to as a “lateral dislodging force.”

While certain embodiments are described herein as including one or more contact surfaces oriented at an oblique angle relative to the longitudinal axis of the fishing line, it will be appreciated that other geometries may be employed to achieve a similar functional result. For example, curved surfaces, cam profiles, tapered channels, offset contact regions, non-linear guide paths, or combinations thereof may be configured such that axial tension applied to the fishing line produces a lateral force component sufficient to urge the fishing line out of the line-retention feature. Accordingly, the invention is not limited to planar oblique contact surfaces, and encompasses any structure configured to translate axial tension in the fishing line into a lateral dislodging force that overcomes the applied retention force.

The contact surface is oriented at an oblique angle relative to the longitudinal axis selected such that, for a given retention force, axial tension applied to the fishing line within an expected operational range produces a lateral force component sufficient to release the fishing line from the line-retention feature when a release condition is satisfied. The specific angle may be selected based on the desired balance between retention during normal use and reliable release during a hook-setting motion or retrieval. The angle may be selected, alone or in combination with the magnitude of the retention force, to calibrate the bobber for particular fishing applications, terminal tackle weights, or species.

### Guide Surfaces

In some embodiments, the bobber body (10) includes one or more guide surfaces (14), shown in FIGS. 1-4, which may comprise recesses, indentations, ramps, tapers, funnels, or lead-in features adjacent to the line-retention feature (16). The guide surfaces (14) are configured to direct the fishing line (26) laterally toward the line-retention feature (16) to facilitate engagement of the fishing line (26) by a user. The guide surfaces (14) may be integrally formed with the bobber body (10) and may include rounded, tapered, or sloped geometries.

### Eyelet

An eyelet (20), shown in FIGS. 1-5, extends through or from the bobber body and is physically spaced apart from the line-retention feature (16). The eyelet (20) defines a through-passage configured to receive the fishing line (26) and permit axial movement of the fishing line (26) after disengagement from the line-retention feature (16).

The eyelet (20) may be implemented as a conventional closed eyelet through which the fishing line is threaded, or as a slotted eyelet having a lateral access opening (22), shown in FIGS. 1-5, that permits the fishing line (26) to be inserted into and removed from the through-passage without threading.

In slotted-eyelet embodiments, the lateral access opening (22) has an unstressed width narrower than the nominal diameter of a fishing line (26) intended for use with the bobber. At least a portion of the eyelet (20) adjacent the lateral access opening (22) comprises a resilient material configured to elastically deform to permit the fishing line (26) to pass through the lateral access opening (22) into the through-passage when a manual seating force is applied. Suitable resilient materials include flexible plastics such as polypropylene, TPU, polyethylene, nylon, or thermoplastic elastomers, silicone, and resilient metals. In embodiments employing a resilient metal element, the eyelet may include a hinge-action or split-leaf configuration in which the metal element flexes about a fixed end to widen the lateral access opening (22) under manual seating force and returns to its unstressed position upon release.

For example, for a 6-pound test monofilament fishing line of approximately 0.25 millimeter diameter, the lateral access opening (22) may be approximately 0.15 to 0.23 millimeter wide. The geometry of the lateral access opening (22) is selected to retain the fishing line (26) during normal fishing operations while permitting deliberate removal when lateral pressure is applied by the user.

### Retention Mechanism

The retention mechanism is associated with the line-retention feature (16) and is configured to apply a retention force that maintains the fishing line (26) within the line-retention feature (16) until an applied force exceeds a release threshold.

In preferred embodiments shown in the drawings, the retention mechanism comprises a biasing arrangement (12), shown separately in FIG. 3 and in assembled position in FIGS. 1, 2, 4, 5, and 6, in the form of a clip, band, or spring element that applies an inward or transverse compressive force to the line-retention feature (16). Examples include spring clips, elastic bands or O-rings that encircle the bobber body (10), leaf springs, and coil springs with pressing elements.

The biasing arrangement (12) may be removable and replaceable, as illustrated by the exploded view of FIG. 3, allowing selection from different retention mechanisms with varying spring rates or compression forces. Different biasing arrangements may be color-coded, marked, or sized to indicate their retention force rating.

The retention mechanism may alternatively or additionally apply retention force through friction, geometric interference, magnetic attraction, or combinations thereof. In magnetic embodiments, one or more permanent magnets are positioned adjacent to the line-retention feature (16) to apply magnetic attraction force to the fishing line (26) or to a ferromagnetic component associated with the fishing line (26).

In some embodiments, the retention mechanism also functions as a weighting element to influence bobber orientation or buoyancy.

### Interchangeable and Adjustable Retention Mechanisms

In some embodiments, the bobber is provided as part of a kit including multiple interchangeable retention mechanisms having different retention force characteristics. For example, a kit may include a light retention mechanism providing a release force of approximately 0.5 to approximately 2 pounds, a medium retention mechanism providing a release force of approximately 3 to approximately 6 pounds, and a heavy retention mechanism providing a release force of approximately 7 to approximately 15 pounds. The interchangeable retention mechanisms may be color-coded for ready identification.

In alternative embodiments, the retention mechanism includes a user-adjustable tension control having a plurality of retention force settings. The adjustable tension control may operate by rotation of a threaded collar, a cam mechanism, sliding adjustment, lever or toggle action, or detent-based click-stop positioning.

### Multiple Line-Retention Features

In some embodiments, the bobber body includes a plurality of line-retention features spaced along the bobber body (10) or positioned at different locations on the bobber body (10). Multiple line-retention features can provide redundant retention, balanced retention when positioned on opposite sides of the bobber body, or user-selectable retention positions.

### Operation

To install the bobber on a fishing line (26), the angler either threads the fishing line through the eyelet (20) or, in slotted-eyelet embodiments, presses the fishing line laterally into the eyelet (20) through the lateral access opening (22), shown in FIGS. 1-5. In the latter case, the resilient material of the eyelet (20) flexes momentarily to allow the fishing line (26) to pass into the through-passage without requiring access to the terminal end of the fishing line (26). Thus, an angler can get their terminal tackle down to a preferred depth and start fishing first, then subsequently attach the bobber afterwards.

After the fishing line (26) is installed in the eyelet (20), the angler positions the terminal tackle at the desired depth below the bobber. The fishing line (26) is then laterally seated within the line-retention feature (16), optionally using the guide surfaces (14) to direct the fishing line (26) into position. FIG. 1 illustrates the bobber in this in-use configuration with the fishing line (26) engaged by the line-retention feature (16) and extending through the eyelet (20) to the hook (24).

The retention mechanism, shown in FIGS. 1-5 as the biasing arrangement (12), applies a retention force sufficient to maintain the fishing line (26) at the selected depth during normal fishing operations. Typical retention force ranges include approximately 0.5 to approximately 2 pounds for light applications, approximately 2 to approximately 6 pounds for medium applications, and approximately 6 to approximately 15 pounds for heavy applications, though other ranges may be selected.

The retention force is calibrated to distinguish between steady-state forces, which are intended not to cause release, and impulsive forces, which are intended to cause release. Steady-state forces include the weight of terminal tackle and hydrodynamic drag generated when a fish takes the bait and swims with it, pulling the submerged bobber through the water. Impulsive forces include the rapid axial tension generated during a hook-setting motion.

When axial tension is applied to the fishing line (26) and a contact surface of the line-retention feature (16) is oriented at an oblique angle relative to the longitudinal axis, a lateral force component develops at the contact surface. When the lateral force component exceeds the retention force applied by the retention mechanism, the fishing line (26) is urged laterally out of the line-retention feature (16).

If disengagement does not occur during the hook-setting motion or retrieval of a hooked fish, axial contact between the bobber body (10) and a fishing rod guide during retrieval may apply a dislodging force to the fishing line (26). In some embodiments, the bobber body (10) has a maximum transverse dimension greater than the internal diameter of a standard fishing rod guide such that contact between the bobber body (10) and the rod guide during retrieval creates interference that applies a lateral force to the fishing line (26).

Following disengagement from the line-retention feature (16), the bobber slides along the fishing line (26) through the eyelet (20). No fixed stop, knot, bead, clip, or other obstruction is affixed to or present on the fishing line.

### Alternative Use as a Suspended Bite Indicator

In certain embodiments, the bobber may be used as a suspended bite indicator rather than as a buoyant float. In this configuration, the bobber is attached to a fishing line extending from a rattle reel, tip-up, or similar ice-fishing apparatus and is suspended vertically above the ice surface. The fishing line is retained within the line-retention feature at a selected position such that the bobber remains suspended in the air under the force of gravity.

When a fish applies tension to the line, the resulting axial tensile force operates on the same principles as the submerged application: the oblique contact surfaces generate a lateral force component, and when that lateral force component exceeds the retention force, the fishing line releases laterally from the line-retention feature while remaining captured within the eyelet.

### Alternative Embodiments

The bobber body may take various shapes including spherical, teardrop-shaped, oval, elongated, cylindrical, bullet-shaped, asymmetrical, or combinations thereof. Shape selection may be optimized for casting distance, visibility, stability in current, ice-shedding or freeze resistance, or wind resistance.

In certain embodiments, the bobber is configured to permit user-adjustable buoyancy through removal of buoyant material. The bobber body, or a buoyant component coupled thereto, may comprise a trimmable foam, cork, or similar material that the user can selectively reduce in volume by cutting, shaving, sanding, or carving. Reducing the volume of buoyant material reduces the overall buoyancy of the bobber, permitting the user to match buoyancy to specific bait weights, terminal tackle configurations, or environmental conditions. The trimmable buoyant material may include visible markings, gradations, or pre-formed score lines indicating incremental buoyancy reductions to assist the user in achieving a desired buoyancy adjustment. The bobber may further include a replaceable or refillable buoyant insert such that buoyant material removed by trimming can be supplemented or replaced without replacing the entire bobber.

The bobber may include visibility features such as high-contrast colors, reflective coatings, photoluminescent materials, or battery-powered illumination.

The line-retention feature may be positioned within a recess in the bobber body or on an exterior surface of the bobber body.

The foregoing description of embodiments has been presented for purposes of illustration and description. It is not intended to be exhaustive or to limit the invention to the precise forms disclosed. Modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and their equivalents.

What is claimed is:

1. A tension-release slip bobber, comprising:
a buoyant bobber body having a longitudinal axis extending between a first end and a second end;
an eyelet coupled to or formed in the bobber body, the eyelet defining a through-passage configured to slidably receive a fishing line;
a line-retention feature formed in or on the bobber body at a location longitudinally spaced from the eyelet, the line-retention feature including an open side configured to laterally receive a segment of the fishing line;
at least one contact surface associated with the line-retention feature, the at least one contact surface being oriented at an oblique angle relative to the longitudinal axis; and
a retention mechanism operatively associated with the line-retention feature and configured to apply a transverse retention force to the segment of the fishing line when the segment is positioned within the line-retention feature;
wherein the at least one contact surface is oriented such that axial tension applied to the fishing line generates a lateral force component acting on the segment of the fishing line;
wherein, when the lateral force component exceeds the transverse retention force, the segment of the fishing line is urged laterally out of the line-retention feature while the fishing line remains within the through-passage of the eyelet; and
wherein no fixed stop, knot, bead, or obstruction is affixed to the fishing line to define a maximum travel position of the bobber.

2. The bobber of claim 1, wherein the line-retention feature comprises an open-sided channel, groove, or slot formed in an exterior surface of the bobber body.

3. The bobber of claim 1, wherein the line-retention feature comprises a plurality of contact points arranged around the segment of the fishing line, the contact points comprising projections, tabs, pins, posts, ridges, or raised surfaces configured to apply distributed retention force.

4. The bobber of claim 1, wherein the retention mechanism comprises a removable and replaceable element selected from the group consisting of a clip, a band, a sleeve, an O-ring, a leaf spring, and a coil spring.

5. The bobber of claim 1, wherein the retention mechanism applies the transverse retention force through at least one of mechanical compression, spring bias, elastic deformation, friction, geometric interference, and magnetic attraction.

6. The bobber of claim 1, wherein the retention mechanism comprises a permanent magnet positioned adjacent the line-retention feature.

7. The bobber of claim 1, wherein the retention mechanism comprises a user-adjustable tension control configured to vary the transverse retention force.

8. The bobber of claim 1, wherein the transverse retention force is selected such that release of the segment of the fishing line from the line-retention feature occurs at an axial tension between approximately 0.5 pounds and approximately 15 pounds.

9. The bobber of claim 1, wherein the bobber body has a maximum transverse dimension greater than 16 millimeters.

10. The bobber of claim 1, further comprising one or more guide surfaces formed on the bobber body and configured to direct the fishing line laterally into the line-retention feature.

11. The bobber of claim 1, wherein the bobber body comprises a plurality of line-retention features positioned at different locations on the bobber body.

12. The bobber of claim 1, wherein the eyelet comprises a slotted eyelet having a lateral access opening communicating with the through-passage, the lateral access opening having an unstressed width smaller than a nominal diameter of the fishing line, and at least a portion of the eyelet adjacent the lateral access opening comprising a resilient material configured to elastically deform to permit lateral insertion of the fishing line.

13. The bobber of claim 12, wherein the resilient material comprises at least one of polypropylene, polyethylene, nylon, thermoplastic elastomer, silicone, and a resilient metal element configured to flex about a fixed end.

14. The bobber of claim 1, in combination with a plurality of interchangeable retention mechanisms, each retention mechanism of the plurality being configured to provide a different transverse retention force.

15. The bobber of claim 1, wherein at least a portion of the bobber body comprises a user-trimmable buoyant material configured to permit user adjustment of bobber buoyancy by removal of material.

16. A threadless slip bobber, comprising:
a buoyant bobber body;
an eyelet defining a through-passage configured to slidably receive a fishing line, the eyelet including a lateral access opening configured to permit lateral insertion of the fishing line into the through-passage without access to a terminal end of the fishing line;
a line-retention feature spaced apart from the eyelet and having an open side configured to laterally receive a segment of the fishing line;
at least one obliquely oriented contact surface positioned to engage the segment of the fishing line; and
a retention mechanism configured to apply a transverse retention force to the segment of the fishing line when the segment is positioned within the line-retention feature;
wherein axial tension applied to the fishing line is converted, via the at least one obliquely oriented contact surface, into a lateral dislodging force acting on the segment, such that the segment is released laterally from the line-retention feature when the lateral dislodging force exceeds the transverse retention force;
wherein, upon release of the segment from the line-retention feature, the fishing line remains within the through-passage of the eyelet such that the bobber transitions to a free-sliding state along the fishing line; and
wherein the bobber is configured to operate without any fixed stop, knot, bead, or obstruction affixed to the fishing line to define a maximum travel position of the bobber.

17. A method of fishing, comprising:
providing a slip bobber comprising a buoyant bobber body, an eyelet defining a through-passage, a line-retention feature spaced apart from the eyelet, at least one contact surface associated with the line-retention feature, and a retention mechanism configured to apply a transverse retention force;
providing a fishing line;
positioning terminal tackle on the fishing line;
engaging the fishing line with the slip bobber by inserting the fishing line into the through-passage of the eyelet and laterally seating a segment of the fishing line within the line-retention feature, wherein the at least one contact surface is oriented at an oblique angle relative to a longitudinal axis of the fishing line;
retaining the slip bobber at a selected position on the fishing line via the transverse retention force applied by the retention mechanism to the segment;
applying axial tension to the fishing line such that the axial tension is converted, via the at least one contact surface, into a lateral dislodging force acting on the segment;
releasing the segment of the fishing line laterally from the line-retention feature when the lateral dislodging force exceeds the transverse retention force, the fishing line remaining within the through-passage of the eyelet during and after said releasing; and
allowing the slip bobber to slide along the fishing line through the eyelet without encountering any fixed stop, knot, bead, or obstruction affixed to the fishing line.

18. The method of claim 17, wherein engaging the fishing line comprises laterally inserting the fishing line through a lateral access opening of the eyelet without removing the terminal tackle from the fishing line.

19. The method of claim 17, wherein the slip bobber is suspended above a body of water, and release of the segment of the fishing line from the line-retention feature provides a bite indication.

20. The method of claim 18, wherein positioning the terminal tackle on the fishing line comprises lowering the terminal tackle to a target depth in a body of water, and wherein engaging the fishing line with the slip bobber is performed after the terminal tackle has been lowered to the target depth.
